(19) United States
(12) Patent Application Publication
(10) Pub. No.: US 2025/0074725 A1
(43) Pub. Date: Mar. 6, 2025

(54) ROBOTIC ARM FOR LOADING AND UNLOADING BINS

(71) Applicant: Ford Global Technologies, LLC, Dearborn, MI (US)

(72) Inventors: Kevin Hwang, Northville, MI (US); Timothy Mark Feldkamp, Ann Arbor, MI (US); Yifan Chen, Ann Arbor, MI (US); Kurt Michael Lundeen, Novi, MI (US); Sam Hoff, Hazel Park, MI (US); Smruti Panigrahi, Novi, MI (US)

(73) Assignee: Ford Global Technologies, LLC, Dearborn, MI (US)

(21) Appl. No.: 18/460,287

(22) Filed: Sep. 1, 2023

(51) Int. Cl. B65G 67/02; B25J 9/16

(52) U.S. Cl. CPC B65G 67/02; B25J 9/161; B25J 9/1664; B25J 9/1679; B65G 2814/0311; B65G 2814/0347

(57) ABSTRACT

A vehicle for delivering a plurality of packages disposed in a plurality of bins is described. The vehicle includes a grid of a plurality of motorized tiles configured to enable movement of the plurality of bins within the vehicle. The vehicle further includes a robotic arm disposed at a vehicle rear portion. The robotic arm may be configured to load or unload a bin to or from the grid of the plurality of motorized tiles. The robotic arm may be attached to a linear actuator that is configured to move the robotic arm in a vehicle interior portion.

### TECHNICAL FIELD

The present disclosure relates to a robotic arm for loading and unloading bins and more particularly to a robotic arm disposed at a vehicle rear portion which is configured to load/unload bins to/from a vehicle.

### BACKGROUND

With the continued growth of internet-based commerce, package delivery is increasingly used to deliver goods to customers. However, the rapid growth also leads to operational challenges in the supply chain. E-commerce companies and their delivery partners deliver an ever-increasing count of packages per day, while reducing resource spend on resources (e.g., labor, fuel consumption, etc.).

Various approaches currently used to optimize delivery volume and standard delivery time of packages include the use of smart routing and smart vehicle allocation. For example, some conventional delivery partners may aggregate delivery of packages with unrelated shipments having similar destination addresses (for example, addresses in the same neighborhood). In other aspects, conventional systems may use a single delivery vehicle to deliver these packages.

Another conventional approach includes sorting and loading of the packages into the delivery vehicle in a preset order, based on the delivery route, to enhance the efficiency of package delivery.

Although the conventional approaches mentioned above may create delivery efficiencies, they are unable to mitigate all the delivery related challenges faced by e-commerce companies and delivery partners. For example, the package unloading from the delivery vehicle for the last mile delivery is still a manual and time-consuming process. Even if the packages are loaded into the delivery vehicle in a preset order, unloading can take a lot of time, especially if the delivery vehicle is large and carries many packages.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example delivery vehicle in which techniques and structures for providing the systems and methods disclosed herein may be implemented.

FIG. 2 illustrates an example inventory management system associated with the delivery vehicle of FIG. 1 in accordance with the present disclosure.

FIG. 3 illustrates a block diagram of an example delivery vehicle in accordance with the present disclosure.

FIG. 4 depicts a view of an example bin unloading operation in accordance with the present disclosure.

FIG. 5 depicts another view of an example bin unloading operation in accordance with the present disclosure.

FIG. 6 depicts a flow diagram of an example method for facilitating loading/unloading operation in accordance with the present disclosure.

### DETAILED DESCRIPTION

### Overview

The present disclosure describes a delivery vehicle configured to deliver a plurality of packages disposed in a plurality of bins. The vehicle may include a robotic arm that may be located at a vehicle rear portion and may facilitate loading or unloading of a bin (having delivery package(s) stored therein) to/from the vehicle. The robotic arm may be coupled to a vertical linear actuator that may be disposed at the vehicle rear portion. The vertical linear actuator may be configured to move the robotic arm vertically up or down along a height of a vehicle sidewall. The robotic arm may include an end effector that may be configured to engage with the bin and move the bin in a vehicle interior portion. In some aspects, the robotic arm may exhibit seven degrees of freedom of movement.

The vehicle may further include a grid of a plurality of motorized tiles on which the plurality of bins may be placed. The plurality of motorized tiles may facilitate bin movement on the grid. Specifically, each tile may include rollers that may be configured to rotate in clockwise or counterclockwise direction to movement of a bin placed on the tile. In addition, each tile may include tile gates on each tile edge. The tile gates may be configured to open or close to facilitate or prevent bin movement on the tile.

The vehicle may additionally include a loading/unloading management system (“system”) that may be configured to manage bin loading/unloading operation in the vehicle. The system may be configured to generate instructions for the robotic arm, the vertical linear actuator, and/or the plurality of motorized tiles to facilitate the bin loading/unloading operation.

For example, the system may generate instructions for one or more tiles to control roller and/or tile gate movement when a bin may be required to be moved on the tiles. The system may further generate instructions to cause robotic arm engagement with the bin (to-be loaded/unloaded) and to enable the robotic arm to slide the bin on the tiles. In some aspects, the system may first transmit instructions to the robotic arm to engage the robotic arm with the bin and then transmit instructions to the tile to open tile gates. Responsive to the tile gates being opened, the system may transmit instructions to the robotic arm to slide the bin on the tiles to load or unload the bin.

The present disclosure is directed towards a vehicle that may facilitate loading and unloading of a bin in the vehicle, by using a robotic arm and motorized tiles. The robotic arm may load/unload bins of any size and dimensions, thus enhancing ease of use. In addition, the robotic arm may be configured to reach to the farthest column and/or row of the grid of motorized tiles to unload a bin from any location in the vehicle. For example, the robotic arm may cover complete vehicle length using the vertical linear actuator.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

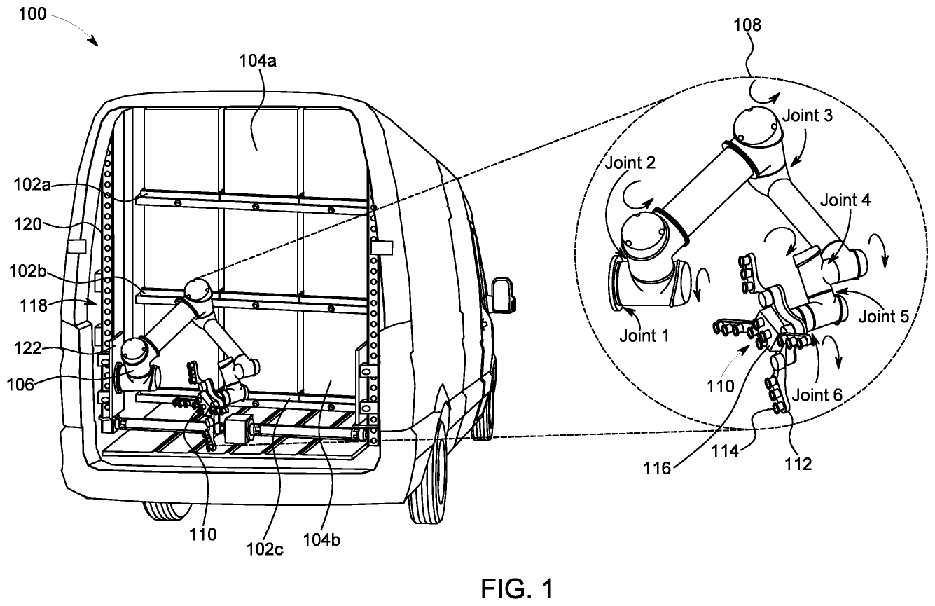

FIG. 1 depicts an example delivery vehicle 100 in which techniques and structures for providing the systems and methods disclosed herein may be implemented. The delivery vehicle 100 may be, but is not limited to, a truck, a van (including walk-in vans), a truck trailer, and/or the like. In some aspects, the delivery vehicle 100 may be an autonomous vehicle. In other aspects, a driver/operator (not shown) may operate the delivery vehicle 100.

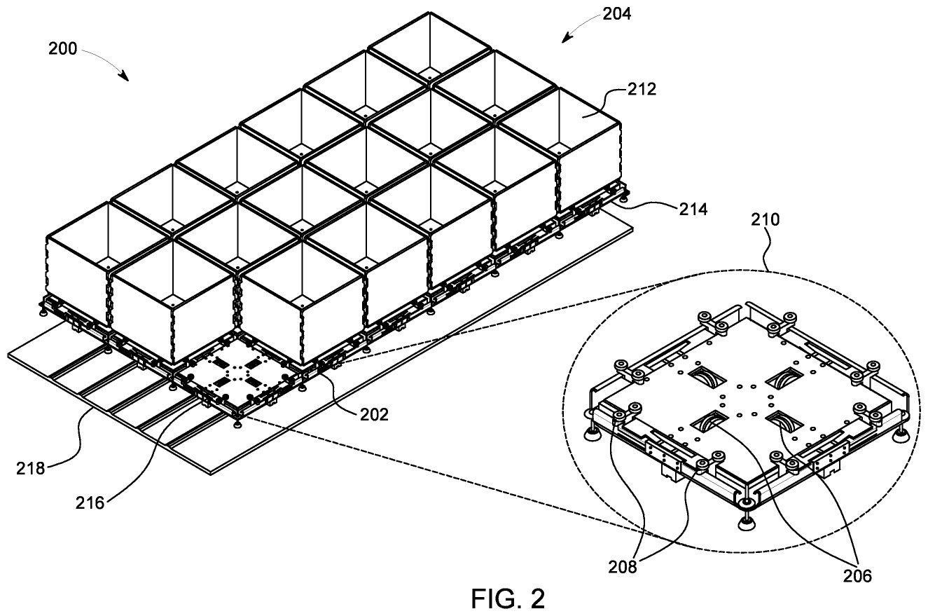

The delivery vehicle 100 may include a plurality of motorized tiles 102a, 102b, 102c (collectively referred to as a plurality of motorized tiles 102). The plurality of motorized tiles 102 may be positioned in a grid or a stack of grids (one over another) forming an array of planar and/or stacked rows and columns of motorized tiles 102. The grid (or array) size and a count of stacks may be changeable based on vehicle size and/or vehicle type. In some aspects, the shape of each motorized tile 102 may be square, rectangular, or take another shape making full use of vehicle cargo bay area(s). The details of the plurality of motorized tiles 102 are described below later in conjunction with FIG. 2.

The delivery vehicle 100 may further include a plurality of bins 104a, 104b (collectively referred to as a plurality of bins 104), placed over the plurality of motorized tiles 102. Each bin 104 may take any shape or configuration such as, for example, a square or a rectangular box disposed to hold delivery packages (delivery packages not shown in FIG. 1) that the delivery vehicle 100 delivers to final destinations along a delivery route.

The plurality of bins 104 may be loaded onto the plurality of motorized tiles 102 (and hence, onto the delivery vehicle 100) in a preset order, as per the delivery sequence of delivery packages contained in each bin 104. Specifically, the plurality of bins 104 may be loaded based on the delivery schedule of each of delivery package, to prevent unnecessary re-arrangement during transit. For instance, the delivery packages that are to be delivered first are placed near the vehicle exit point, and the packages that are to be delivered at the last are placed far from the vehicle exit point.

Similarly, the delivery packages may also be loaded in the plurality of bins 104 based on the package delivery schedule. In addition, the delivery packages may be loaded in the plurality of bins 104 based on package size, dimension, shape, and weight, to optimize bin usage.

In some aspects, the plurality of motorized tiles 102 may be configured to enable bin movement within the delivery vehicle 100.

The delivery vehicle 100 may further include a robotic arm 106 that may be disposed at a vehicle rear portion. The robotic arm 106 may be configured to load or unload the plurality of bins 104 to/from the delivery vehicle 100 (e.g., to/from the plurality of motorized tiles 102). In an exemplary aspect, the robotic arm 106 may include a plurality of movable elements (e.g., shoulder, elbow, and wrist) coupled to one another via one or more joints (including joints 1-6 shown in view 108 of FIG. 1) defining one or more degrees of freedom of movement for each movable element. In the exemplary aspect depicted in FIG. 1, the plurality of movable elements may exhibit six degrees of freedom of movement. The present disclosure is not limited to the exemplary aspect depicted in FIG. 1, and in other aspects (not shown), the robotic arm 106 may include more or less joints and hence may exhibit more or less degrees of freedom of movement.

In some aspects, a movable element may include an end effector 110 that may be configured to engage with the plurality of bins 104 to load or unload the plurality of bins 104. The end effector 110 may include a gripper (e.g., a pneumatic gripper or suction cup) that may be configured to engage (e.g., grip/hold) with the plurality of bins 104 by generating negative pressure. The present disclosure is not limited to the type of gripper depicted in FIG. 1, and the robotic arm 106 may operate equally efficiently if other types of grippers are used in the robotic arm 106.

The end effector 110 may be of any shape and size depending upon an item (e.g., the bin 104) to be gripped by the end effector 110. For example, the end effector 110 may include a plurality of fingers 112 (e.g., four fingers that may be disposed at 90 degrees with respect to each other, as depicted in the view 108), and each finger 112 may include a plurality of suction cups 114 as depicted in FIG. 1. In some aspects, the end effector 110 may include a center portion 116 and each finger 112 may be connected to the center portion 116. In further aspects, the center portion 116 may include additional suction cups for better gripping of items/bins.

In some aspects, the robotic arm 106 may include a robotic arm proximal end and a robotic arm distal end. The end effector 110 may be disposed at the robotic arm distal end. The robotic arm proximal end may be attached to a vertical linear actuator 118. Stated another way, the robotic arm 106 may be coupled to the vertical linear actuator 118 via the robotic arm proximal end. The vertical linear actuator 118 may be disposed at the vehicle rear portion and may be configured to move the robotic arm 106 vertically up or down along the vehicle height. Specifically, the vertical linear actuator 118 may be disposed in proximity to a vehicle sidewall (as depicted in FIG. 1) and may be configured to move the robotic arm 106 along the sidewall height.

In some aspects, the vertical linear actuator 118 may include a linear guide 120 and a wheel plate 122 that may be connected to the robotic arm proximal end. The wheel plate 122 may be configured to move vertically on the linear guide 120, thereby moving the robotic arm 106 vertically in the vehicle interior portion. In further aspects, the vertical linear actuator 118 may be any type of actuator including, but not limited to, a mechanical or electro mechanical actuator, a hydraulic actuator, a pneumatic actuator, a piezoelectric actuator, and/or the like.

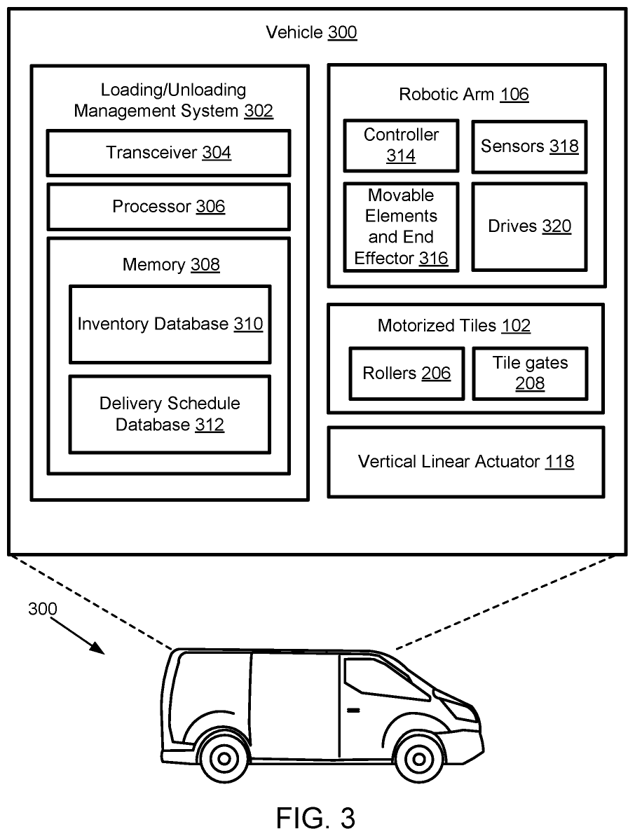

The delivery vehicle 100 may further include a loading/unloading management system (shown as loading/unloading management system 302 in FIG. 3) that may be configured to manage bin loading or unloading into/from the delivery vehicle 100. Specifically, the loading/unloading management system (or system) may be configured to control operations of the robotic arm 106 and the plurality of motorized tiles 102 to autonomously perform bin loading or unloading. The details of system operation may be understood in conjunction with FIG. 3 described later below.

Although the present disclosure describes use of a single robotic arm, the delivery vehicle 100 may include a plurality of robotic arms without departing from the present disclosure scope. For example, the delivery vehicle 100 may include two robotic arms that may be located on two opposite vehicle side walls. In some aspects, the two robotic arms may perform the operation of bin loading or unloading without interfering movement of each other. In addition, although the present disclosure describes use of the vertical linear actuator 118, the delivery vehicle 100 may additionally or alternatively include horizontal linear actuator to move the robotic arm horizontally in the vehicle interior portion. In some aspects, the horizontal linear actuator may be disposed in proximity to vehicle floor.

The delivery vehicle 100 implements and/or perform operations, as described here in the present disclosure, in accordance with the owner manual and safety guidelines.

FIG. 2 illustrates an example inventory management system 200 associated with the delivery vehicle 100, in accordance with the present disclosure. FIG. 2 illustrates a bed/grid of a plurality of motorized tiles 202 and a plurality of bins 204 that is disposed proximate to and/or positioned on the plurality of motorized tiles 202. The plurality of motorized tiles 202 may be same as the plurality of motorized tiles 102, and the plurality of bins 204 may be same as the plurality of bins 104. As described above, the plurality of motorized tiles 202 may be configured to move and/or reposition the plurality of bins 204 throughout the delivery vehicle 100.

Each motorized tile 202 may include a plurality of wheels or rollers 206 and a plurality of tile gates 208, as shown in view 210 of FIG. 2. In some aspects, each motorized tile 202 may include four rollers 206 configured to move a bin 204 on a motorized tile 202 when the bin 204 may be placed on the motorized tile 202. The plurality of rollers 206 may be configured to rotate in clockwise or counterclockwise direction to move the bin 204 on the motorized tile 202. In further aspects, each motorized tile 202 may include eight tile gates 208. In an exemplary aspect, two tile gates may be disposed on each tile side/edge. The tile gates 208 may be configured to open or close to facilitate or prevent bin movement on the tile. In some aspects, the tile gates 208 may be configured to slide horizontally (e.g., sideways) along the tile edges to facilitate or prevent bin movement. For example, the tile gates on a first tile edge may move towards the first tile edge corners to facilitate bin movement through the first tile edge, and the tile gates on the first tile edge may move towards a first tile edge middle portion to prevent bin movement through the first tile edge.

In some aspects, the plurality of rollers 206 and the plurality of tile gates 208 may be coupled with one or more tile actuators (not shown in FIG. 2). The tile actuators may actuate a part, or all the plurality of rollers 206 and the plurality of tile gates 208 to enable bin movement on the grid of plurality of motorized tiles 202 (e.g., based on delivery schedule of the packages loaded in the plurality of bins 204). For instance, if a package is to be delivered at the next delivery station, the tile actuators may only actuate rollers/tile gates that may cause to move or assist in moving a bin 212 containing the package from its current location 214 to an exit point (or a destination location 216) on the grid of plurality of motorized tiles 202. The destination location 216 may be, for example, the point on the grid from where a vehicle operator or a drone (not shown in FIG. 2) may easily pick the package, with minimal effort.

In some aspects, the tile actuators may be and/or include one or more servomotors that may be configured to receive an actuation signal from the loading/unloading management system described briefly above in conjunction with FIG. 1 and in detail below in conjunction with FIG. 3. In particular, the loading/unloading management system may provide a first actuation signal (i.e. supply a voltage at a first polarity) to a first tile actuator(s) to make roller(s) (e.g., the rollers 206), coupled to the first tile actuator, rotate in a first/clockwise direction. Similarly, the loading/unloading management system may provide a second actuation signal (i.e., supply the voltage at a second polarity) to a second tile actuator(s) to make the rollers 206, connected to the second tile actuator(s), rotate in a second/counterclockwise direction. In this manner, by changing the voltage polarity, the loading/unloading management system may enable roller movement in either a clockwise or a counterclockwise direction, thereby enabling bin movement within the delivery vehicle 100 or on the grid of plurality of motorized tiles 202. Similarly, the loading/unloading management system may provide instructions to the tile actuators to open or close the tile gates 208.

As an example, the loading/unloading management system may send a signal to one or more tile actuators to move a specific bin (such as the bin 212 containing the package) from its current location 214 to the destination location 216 within the grid. Based on the received signal, the tile actuators may operate respective rollers/tile gates to enable the bin movement from the current location 214 to the destination location 216.

In further aspects, the grid of plurality of motorized tiles 202 may be mounted on a base 218. In some aspects, the base 218 may be constructed of metal such as iron, steel, aluminum, or a combination thereof and may couple to the tile actuators such that the tile actuators may provide package and bin repositioning in two or three axes.

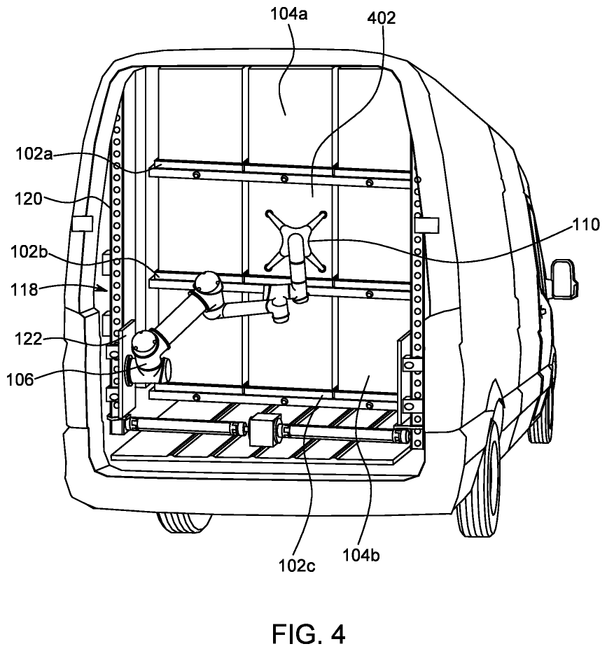

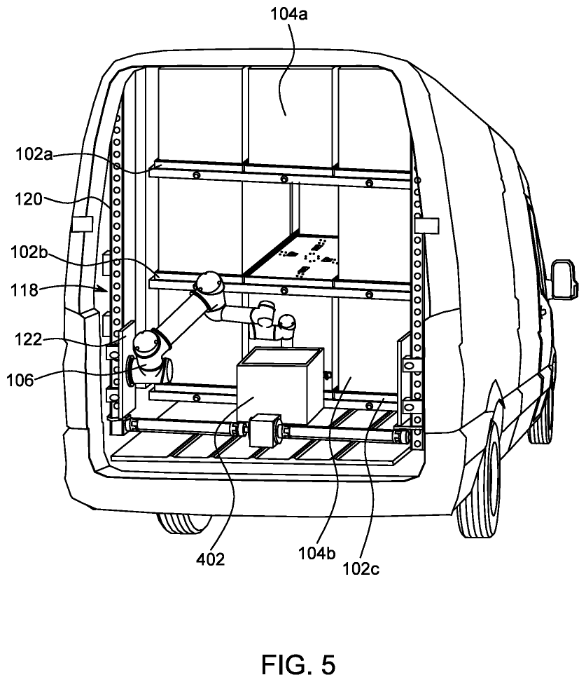

FIG. 3 illustrates a block diagram of an example delivery vehicle 300 in accordance with the present disclosure. The delivery vehicle 300 may be same as the delivery vehicle 100 described above. FIG. 3 will be explained in conjunction with FIGS. 4-5. FIGS. 4 and 5 depict views of an example bin unloading operation, in accordance with the present disclosure.

The delivery vehicle 300 may include a loading/unloading management system 302 (hereinafter referred to as system 302), which may be configured to manage loading or unloading of bins in the delivery vehicle 300.

The system 302 may include a plurality of components including, but not limited to, a transceiver 304, a processor 306 and a memory 308, which are communicatively coupled to each other. The transceiver 304 may be configured to exchange information/data/signals with external devices or vehicle components (such as the robotic arm 106). The memory 308 may store programs in code and/or store data for performing various system operations in accordance with the present disclosure. Specifically, the processor 306 may be configured and/or programmed to execute computer-executable instructions stored in the memory 308 for performing various system functions in accordance with the disclosure. Consequently, the memory 308 may be used for storing code and/or data code and/or data for performing operations in accordance with the present disclosure.

In some aspects, the processor 306 may be disposed in communication with one or more memory devices (e.g., the memory 308 and/or one or more external databases (not shown in FIG. 3)). The memory 308 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 308 may be one example of a non-transitory computer-readable storage medium or memory and may be used to store programs in code and/or to store data for performing various operations in accordance with the disclosure. The instructions in the memory 308 can include one or more separate programs, each of which can include an ordered listing of computer-executable instructions for implementing logical functions.

In some aspects, the memory 308 may store a plurality of information/dataset in one or more databases. Examples of such databases include, but are not limited to, an inventory database 310, a delivery schedule database 312, and/or the like.

The inventory database 310 may be configured to store information associated with inventory loaded in the delivery vehicle 300. The information (e.g., real-time information) associated with the inventory may include, for example, package size/dimension, package weight, packet shape, and/or the like associated with each delivery package in the delivery vehicle 300. The information may further include bin size (e.g., the plurality of bins 204) in which the packages may be placed and a mapping of the plurality of packages with the plurality of bins 204 (e.g., which package is placed in which bin), and/or the like. Furthermore, the information may include a mapping of the plurality of bins 204 with the plurality of motorized tiles 202 (e.g., location of each bin 204 on the plurality of motorized tiles 202).

The delivery schedule database 312 may include information associated with delivery of packages (e.g., inventory) loaded in the delivery vehicle 300. For example, the delivery information may include delivery route, sequence of package delivery, date and time for the delivery, customer information (such as contact details, delivery address, etc.), and/or the like.

The delivery vehicle 300 may further include the robotic arm 106, the plurality of motorized tiles 102, and the vertical linear actuator 118, as described above in conjunction with FIG. 1. The plurality of motorized tiles 102 may include the rollers 206 and the tile gates 208, as described above in conjunction with FIG. 2.

The robotic arm 106 may include a plurality of components including, but not limited to, a controller 314, a plurality of movable elements and end effector 316 (the end effector may be same as the end effector 110 described above), one or more sensors 318, one or more drives 320, and/or the like. The controller 314 may be configured to control movement of the plurality of movable elements and end effector 110 to enable bin loading and unloading. For example, the controller 314 may be configured to control 3-dimensional (3D) movement of the plurality of movable elements to facilitate the robotic arm 106 to reach to any location in the delivery vehicle 300 to unload a bin (e.g., the bin 204). In some aspects, the controller 314 may be configured to obtain an instruction from the processor 306 and may control the robotic arm 106 to perform the loading or unloading operation based on the obtained instruction. In some aspects, the instruction may include information associated with the bin 204 to be loaded/unloaded, which in turn may include source and destination location associated with the bin 204 and a predetermined path on the grid of plurality of motorized tiles 202 to load or unload the bin 204.

As described above, the movable elements (e.g., shoulder, elbow, and wrist) may be coupled to one another via the one or more joints (e.g., joints 1-6 depicted in view 108 of FIG. 1) defining one or more degrees of freedom of movement for each movable element. A movable element may be attached to the end effector (such as the end effector 110) to engage with the bin 204 to load or unload the bin 204. The end effector 110 may be configured to receive instruction from the controller 314 and may engage with the bin 204 based on the received instruction. In some aspects, the end effector 110 may be configured to modify holding power to hold different types of objects or bins of different shapes, dimensions and/or weight.

In some aspects, the sensors 318 may include one or more proximity sensors, door sensors, radio detection and ranging (radar) sensors, and/or the like. The sensor 318 may be configured to detect an obstruction/object in proximity to the robotic arm 106 (e.g., to prevent interference with another robotic arm or vehicle rear gate/door). The controller 314 may be configured to obtain inputs from the sensor 318 and may control robotic arm operation based on the inputs obtained from the sensors 318. For example, the controller 314 may pause robotic arm movement when the vehicle rear gate may be open, as determined by using the inputs obtained from the sensors 318.

The drives 320 may include components including motors to control movement and maneuvering of the joints 1-6. The drives 320 may be configured to control movement and maneuvering between the joints 1-6 based on instructions received from the controller 314.

In some aspects, the robotic arm 106 (e.g., robotic arm components) may be powered by a power system that may be separate from vehicle electrical system. For example, the robotic arm 106 may be powered by a power system that may be disposed on a delivery vehicle side wall or below/under the motorized tiles 202.

The processor 306 may be configured to facilitate loading/unloading operation to/from the delivery vehicle 300. Specifically, the processor 306 may be configured to control operations of the robotic arm 106 (via the controller 314), the plurality of motorized tiles 202, and/or the vertical linear actuator 118 to enable efficient loading/unloading operation.

In operation, the processor 306 may obtain information from the inventory database 310 and the delivery schedule database 312 (e.g., to perform unloading operation). Responsive to obtaining the information, the processor 306 may determine a package (for example, a target package) that may be scheduled for delivery at the next delivery location in the delivery route. The processor may then identify a bin (for example, a target bin 402, as shown in FIG. 4) that may include the determined target package and the current and destination location associated with the target bin on the plurality of motorized tiles 202, based on the obtained information. In some aspects, the processor 306 may fetch the mapping of the packages with the bins from the inventory database 310 and may determine the target bin current location based on the mapping. The destination location may be, for example, near a vehicle exit door or a vehicle pick-up door, from where a vehicle operator or a drone may conveniently pick the target package from the target bin 402.

Responsive to determining the target bin 402, its current location, and the destination location, the processor 306 may fetch a movement plan (for example, pre-calculated path), to move the target bin 402 from its current to the destination location. The path may be pre-stored in the memory 308, and the processor 306 may fetch the path from the memory 308.

Responsive to fetching the movement plan/pre-calculated path, the processor 306 may generate instructions for the robotic arm 106, the plurality of motorized tiles 102, and/or the vertical linear actuator 118 to perform the unloading operation. For example, the processor 306 may generate first instructions for the robotic arm 106, second instructions for the plurality of motorized tiles 102, and third instructions for the vertical linear actuator 118 to efficiently perform the unloading operation. In some aspects, the processor 306 may generate the instructions described above based on the fetched movement plan. Responsive to generating the instructions, the processor 306 may transmit respective instructions to the robotic arm 106, the plurality of motorized tiles 102, and/or the vertical linear actuator 118.

In some aspects, the first instructions transmitted to the robotic arm 106 may include an engagement instruction to engage with the target bin 402. In some aspects, the processor 306 may transmit the engagement instruction to the controller 314 (e.g., via the transceiver 304). The controller 314 may receive the engagement instruction and may control 3D movement of the robotic arm 106 by controlling the movable elements and may control the end effector 110 to engage with the target bin 402. In some aspects, the first instruction may include the current location associated with the target bin 402 and a predetermined path on the grid of motorized tiles 202 to reach to the target bin 402. An engaged position of the robotic arm 106 and the target bin 402 is depicted in FIG. 4.

In further aspects, the processor 306 may transmit the third instructions to the vertical linear actuator 118 to facilitate the robotic arm 106 to reach to the source location at which the target bin 402 may be disposed on the grid of motorized tiles 202. The vertical linear actuator 118 may receive the third instructions and may move the robotic arm proximal end vertically by moving the wheel plate 122 on the linear guide 120. In some aspects, the processor 306 may transmit the third instructions to the vertical linear actuator 118 to move the robotic arm 106 up or down when the processor 306 determines that the robotic arm 106 may obstruct any other operation inside the delivery vehicle 300.

In further aspects, the processor 306 may transmit the second instructions to one or more motorized tiles of the plurality of motorized tiles 102 to open or close tile gates associated with the motorized tiles to enable target bin unloading. Specifically, the processor 306 may transmit the second instructions when the robotic arm 106 may be engaged with the target bin 402. For example, when the robotic arm 106 may be engaged with the target bin 402 (e.g., via the end effector 110), the processor 306 may transmit the second instructions to tile gates (e.g., via the tile actuators described in conjunction with FIG. 2) associated with the tile on which the target bin 402 may be placed, to open the tile gates (e.g., the tile gates on a front tile edge).

When the tile gates may be opened, the processor 306 may transmit a slide instruction to the controller 314 (associated with the robotic arm 106) to slide the target bin 402 and place the target bin 402 on the destination location. The controller 314 may receive the slide instruction and may slide the target bin 402 and move the target bin 402 to the destination location (as depicted in FIG. 5). When the target bin 402 moves to the destination location, the vehicle operator or the drone may pick the corresponding target package from the target bin 402 for last mile delivery.

In some aspects, the robotic arm 106 may be additionally configured to place the target bin 402 outside the delivery vehicle 300. In further aspects, the robotic arm 106 may hand off the target bin 402 to another robotic arm (not shown). In additional aspects, the robotic arm 106 may pick the target package from the target bin 402 and may unload the target package from the target bin 402.

In a manner similar to the one described above, the processor 306 may generate the first instructions, the second instructions, the third instructions to perform loading operation for one or more bins. In this case, the processor 306 may determine a “loading” movement plan to move a bin to a destination location on a tile and generate instructions based on the loading movement plan. Responsive to generating the instructions, the processor 306 may transmit respective instructions to the robotic arm 106, the plurality of motorized tiles 102, and/or the vertical linear actuator 118 to enable efficient loading operation.

When the bins may be required to be loaded in the delivery vehicle 300, the first instructions may include an engagement instruction to engage with a target bin to be loaded in the delivery vehicle 300 (e.g., on a destination tile from a vehicle floor). The controller 314 may receive the engagement instruction and may control 3D movement of the robotic arm 106 by controlling the movable elements and may control the end effector 110 to engage with the target bin. The processor 306 may further transmit the third instruction to the vertical linear actuator 118 to facilitate the robotic arm 106 to reach to a source location at which the target bin may be disposed. In addition, the processor 306 may transmit the second instructions to one or more motorized tiles to open or close tile gates associated with the motorized tiles to enable target bin loading on the destination tile. Specifically, the processor 306 may transmit the second instructions when the robotic arm 106 may be engaged with the target bin. When the tile gates may be opened, the processor 306 may transmit the slide instruction to the controller 616 to cause the robotic arm 106 to slide and load the target bin on the destination location/tile. controller 314. In this manner, the processor 306 facilitates efficient bin loading operation.

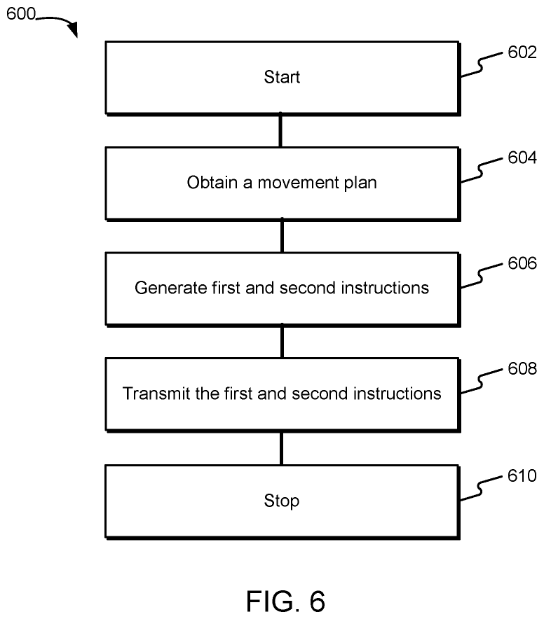

FIG. 6 depicts a flow diagram of an example method 600 for facilitating loading/unloading operation, in accordance with the present disclosure. FIG. 6 may be described with continued reference to prior figures, including FIGS. 1-5. The following process is exemplary and not confined to the steps described hereafter. Moreover, alternative embodiments may include more or less steps than are shown or described herein and may include these steps in a different order than the order described in the following example embodiments.

At step 602, the method 600 commences. At step 604, the method 600 may include obtaining, by the processor 306, a movement plan to move a bin from a source location to a destination location (e.g., from the memory 308) in the delivery vehicle 300. In some aspects, the movement plan may be associated with a predefined path for bin movement on the plurality of motorized tiles 202 to enable efficient bin unloading or loading from/to the delivery vehicle 300.

At step 606, the method 600 may include generating, by the processor 306, the first instructions and the second instructions based on the movement plan. The first instructions may be associated with tile gate and/or roller movement for one or more motorized tiles to enable bin loading/unloading. The second instructions may be associated with robotic arm movement to enable bin loading/unloading, as described above. At step 608, the method 600 may include transmitting, by the processor 306, the first instructions and the second instructions to the one or more motorized tiles and the robotic arm 106 to enable bin movement from the source location to the destination location.

The method 600 ends at step 610.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a grid of a plurality of motorized tiles configured to enable movement of a plurality of bins within the vehicle; and
a robotic arm disposed at a vehicle rear portion, wherein the robotic arm is configured to load or unload a bin of the plurality of bins to or from the grid of the plurality of motorized tiles, and wherein the robotic arm is attached to a linear actuator that is configured to move the robotic arm in a vehicle interior portion.

2. The vehicle of claim 1, wherein the robotic arm comprises a plurality of movable elements coupled to one another via one or more joints defining one or more degrees of freedom of movement for each of the plurality of movable elements.

3. The vehicle of claim 2, wherein the robotic arm exhibits seven degrees of freedom of movement.

4. The vehicle of claim 2, wherein a movable element of the plurality of movable elements comprises an end effector that is configured to engage with the bin to load or unload the bin.

5. The vehicle of claim 4, wherein the end effector comprises a gripper.

6. The vehicle of claim 4, wherein the robotic arm further comprises a proximal end and a distal end, and wherein the end effector is disposed at the distal end.

7. The vehicle of claim 6, wherein the proximal end is attached to the linear actuator.

8. The vehicle of claim 1, wherein the linear actuator is disposed at the vehicle rear portion.

9. The vehicle of claim 1 further comprising a processor configured to provide first instructions to the robotic arm to load or unload the bin.

10. The vehicle of claim 9, wherein the first instructions comprise an engagement instruction to engage with the bin, and wherein the robotic arm is configured to receive the engagement instruction from the processor and engage with the bin.

11. The vehicle of claim 9, wherein the first instructions comprise a bin location and a predetermined path on the grid of the plurality of motorized tiles to load or unload the bin.

12. The vehicle of claim 10, wherein the processor is further configured to provide second instructions to one or more motorized tiles of the plurality of motorized tiles to open or close tile gates associated with the one or more motorized tiles to enable loading or unloading of the bin.

13. The vehicle of claim 12, wherein the processor is configured to provide the second instructions when the robotic arm engages with the bin.

14. The vehicle of claim 12, wherein the first instructions further comprise a slide instruction to slide the bin on the one or more motorized tiles to load or unload the bin, and wherein the robotic arm is configured to receive the slide instruction and slide the bin on the one or more motorized tiles.

15. A method comprising:
obtaining, by a processor, a movement plan to move a bin from a source location to a destination location in a vehicle;
generating, by the processor, first instructions for one or more motorized tiles of a plurality of motorized tiles based on the movement plan, wherein a grid of the plurality of motorized tiles is configured to enable movement of a plurality of bins within the vehicle based on the first instructions; and
generating, by the processor, second instructions for a robotic arm based on the movement plan, wherein the robotic arm is disposed at a vehicle rear portion, wherein the robotic arm is configured to move the bin from the source location to the destination location on the grid of the plurality of motorized tiles based on the second instructions, and wherein the robotic arm is attached to a linear actuator that is configured to move the robotic arm in a vehicle interior portion; and
transmitting, by the processor, the first instructions and the second instructions to the one or more motorized tiles and the robotic arm to move the bin from the source location to the destination location.

16. The method of claim 15, wherein the second instructions comprise an engagement instruction to engage with the bin, and wherein the robotic arm is configured to receive the engagement instruction from the processor and engage with the bin.

17. The method of claim 15, wherein the second instructions comprise a bin location and a predetermined path on the grid of the plurality of motorized tiles to load or unload the bin.

18. The method of claim 15, wherein the first instructions comprise instructions to open or close tile gates associated with the one or more motorized tiles to enable loading or unloading of the bin.

19. The method of claim 15, wherein the second instructions further comprise a slide instruction to slide the bin on the one or more motorized tiles to load or unload the bin, and wherein the robotic arm is configured to receive the slide instruction and slide the bin on the one or more motorized tiles.

20. A non-transitory computer-readable storage medium in a distributed computing system, the non-transitory computer-readable storage medium having instructions stored thereupon which, when executed by a processor, cause the processor to:
obtain a movement plan to move a bin from a source location to a destination location in a vehicle;
generate first instructions for one or more motorized tiles of a plurality of motorized tiles based on the movement plan based on the movement plan, wherein a grid of the plurality of motorized tiles is configured to enable movement of a plurality of bins within the vehicle based on the first instructions; and
generate second instructions for a robotic arm based on the movement plan, wherein the robotic arm is disposed at a vehicle rear portion, wherein the robotic arm is configured to move the bin from the source location to the destination location on the grid of the plurality of the motorized tiles, and wherein the robotic arm is attached to a linear actuator that is configured to move the robotic arm in a vehicle interior portion; and
transmit the first instructions and the second instructions to the one or more motorized tiles and the robotic arm to move the bin from the source location to the destination location.
